(19) United States
(12) Patent Application Publication
(10) Pub. No.: US 2018/0359727 A1
(43) Pub. Date: Dec. 13, 2018

(54) WIRELESS COMMUNICATION APPARATUS, WIRELESS COMMUNICATION METHOD, AND COMPUTER READABLE MEDIUM

(71) Applicant: MITSUBISHI ELECTRIC CORPORATION, Tokyo (JP)

(72) Inventor: Toshinori HORI, Tokyo (JP)

(73) Assignee: MITSUBISHI ELECTRIC CORPORATION, Tokyo (JP)

(21) Appl. No.: 15/779,217

(22) PCT Filed: Jan. 21, 2016
(86) PCT No.: PCT/JP2016/051733

§ 371 Date: May 25, 2018

(51) Int. Cl. H04W 72/02; H04W 76/10; H04W 24/02; H04W 76/20; H04W 28/06

(52) U.S. Cl. CPC H04W 72/02; H04W 76/10; H04W 28/06; H04W 76/20; H04W 24/02

(57) ABSTRACT

A plurality of wireless communication channels (30) are set between a wireless communication apparatus (20) and a communication destination apparatus (10). The wireless communication apparatus (20) receives connection check response data, which is a response from the communication destination apparatus (10) in response to connection check request data transmitted to the communication destination apparatus (10) through any of the wireless communication channels (30), through the wireless communication channel (30) through which the connection check request data have been transmitted. In addition, the wireless communication apparatus (20) analyzes a condition of reception of the connection check response data of each of the wireless communication channels, and selects a wireless communication channel (30) through which connection check request data is to be transmitted, from among a plurality of wireless communication channels (30), on the basis of a result of analysis. The wireless communication apparatus (20) then transmits the connection check request data to the communication destination apparatus (10) through the selected wireless communication channel (30).

### TECHNICAL FIELD

The present invention relates to wireless communication.

### BACKGROUND ART

In recent years, there have been increasing expectations on wireless communication based on demands for easiness of changes in layouts and saving lines. While high reliability is required for communication for controlling industrial devices, temporary degradation in communication quality occurs during wireless communication owing to fluctuations and the like in communication channels. In general, antenna diversity technologies, retransmission technologies, and the like are present as technologies for improving the quality of wireless communication. In addition, a method for exchanging connection check request data and connection check response data to periodically check the conditions of connection at a transmitting side and a receiving side has been known, as a method for checking whether data communication is successful.

Patent Literature 1 discloses a technology for dealing with failures of communication devices and networks. More specifically, according to the technology of Patent Literature 1, a communication device at a transmitting side allocates a sequence number to a packet and transmits the packet through a plurality of communication channels over a wired network. When a communication device at a receiving side receives a plurality of packets to which the same sequence number is allocated, the communication device at a receiving side keeps one of the packets and discards the other packets. Patent Literature 1 uses such redundant communication channels to deal with failures of communication devices and networks.

### CITATION LIST

### Patent Literature

Patent Literature 1: JP 2001-036977 A

### SUMMARY OF INVENTION

### Technical Problem

When the technology of Patent Literature 1 is applied to transmission and reception of connection check request data and connection check response data in wireless communication, the connection check request data and the connection check response data are transmitted and received through a plurality of wireless communication channels. Wireless communication channels, however, have narrower communication bands than wired communication channels. Thus, when connection check request data and connection check response data are transmitted and received through a plurality of wireless communication channels, the communication bands are consumed by the transmission and reception of the connection check request data and the connection check response data, which causes such situations as sufficient communication bands are not reserved for communication of user data. In other words, there is a problem that precious frequency resources are consumed by communication for checking the conditions of connections.

A major object of the present invention is to solve the problem described above and to flexibly select a wireless communication channel to be used for communication for checking a connection condition, so as to improve the frequency efficiency.

### Solution to Problem

A wireless communication apparatus for which a plurality of wireless communication channels are set between the wireless communication apparatus and a communication destination apparatus, the wireless communication apparatus includes:

a receiving unit to receive connection check response data being a response from the communication destination apparatus in response to connection check request data transmitted to the communication destination apparatus through any of the wireless communication channels, through the wireless communication channel through which the connection check request data have been transmitted;

an analyzing unit to analyze a condition of reception of the connection check response data of each of the wireless communication channels;

a wireless communication channel selecting unit to select a wireless communication channel through which the connection check request data is to be transmitted, from among the wireless communication channels, on the basis of a result of analysis of the analyzing unit; and

a transmitting unit to transmit the connection check request data to the communication destination apparatus through the wireless communication channel selected by the wireless communication channel selecting unit.

### Advantageous Effects of Invention

In the present invention, a wireless communication channel through which connection check request data is to be transmitted is selected on the basis of the condition of reception of connection check response data, and the connection check request data is transmitted through the selected wireless communication channel. Thus, connection check request data can be transmitted only through an appropriate wireless communication channel depending on the condition of reception of connection check response data, which improves the frequency efficiency.

### BRIEF DESCRIPTION OF DRAWINGS

FIG. 1 is a diagram illustrating an example of a system configuration of a wireless communication system according to a first embodiment.

FIG. 2 is a diagram illustrating an example of a functional configuration of a wireless child station apparatus according to the first embodiment.

FIG. 3 is a diagram illustrating an example of a hardware configuration of the wireless child station apparatus according to the first embodiment.

FIG. 4 is a diagram illustrating an example of a functional configuration of a wireless parent station apparatus according to the first embodiment.

FIG. 5 is a diagram illustrating an example of a hardware configuration of the wireless child station apparatus according to the first embodiment.

FIG. 6 is a flowchart illustrating an example of operation of the wireless child station apparatus according to the first embodiment.

FIG. 7 is a flowchart illustrating an example of operation of the wireless child station apparatus according to the first embodiment.

FIG. 8 is a table illustrating an example of a rank table according to the first embodiment.

FIG. 9 is a flowchart illustrating an example of operation of a wireless child station apparatus according to a second embodiment.

FIG. 10 is a flowchart illustrating an example of operation of the wireless child station apparatus according to the second embodiment.

### DESCRIPTION OF EMBODIMENTS

### First Embodiment

### ***Description of Configuration***

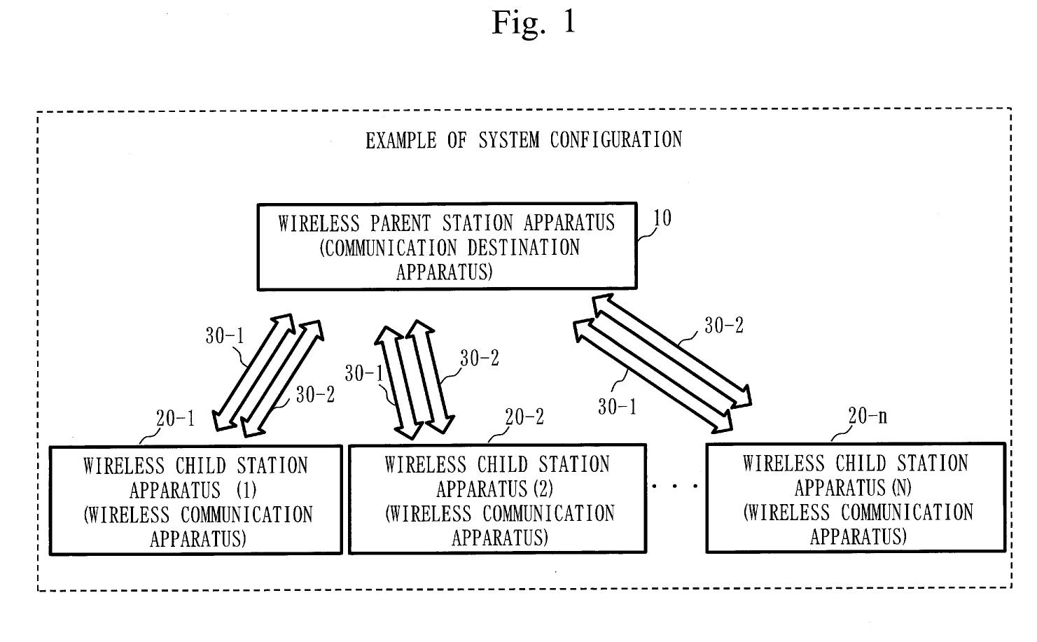

FIG. 1 illustrates an example of a system configuration of a wireless communication system according to the present embodiment. In the wireless communication system according to the present embodiment, one wireless parent station apparatus 10 and n wireless child station apparatuses 20 perform wireless communication.

Hereinafter, the n wireless child station apparatuses 20 will be referred to as a wireless child station apparatus (1) 20-1, a wireless child station apparatus (2) 20-2, . . . , and a wireless child station apparatus (n) 20-n.

When the wireless child station apparatus (1) 20-1, the wireless child station apparatus (2) 20-2, . . . , and the wireless child station apparatus (n) 20-n need not be distinguished from each other, the wireless child station apparatus (1) 20-1, the wireless child station apparatus (2) 20-2, . . . , and the wireless child station apparatus (n) 20-n will be collectively referred to as wireless child station apparatus 20.

A first wireless communication channel 30-1 and a second wireless communication channel second wireless communication channel 30-2 are set between the wireless parent station apparatus 10 and each of the wireless child station apparatuses 20. When the first wireless communication channel 30-1 and the second wireless communication channel 30-2 need not be distinguished from each other, the first wireless communication channel 30-1 and the second wireless communication channel 30-2 will be collectively referred to as wireless communication channel 30.

The first wireless communication channel 30-1 and the second wireless communication channel 30-2 are distinguished from each other by frequency, for example. Alternatively, the first wireless communication channel 30-1 and the second wireless communication channel 30-2 may be distinguished from each other by codes.

A first wireless communication channel 30-1 and a first wireless communication channel 30-1 for different wireless child station apparatuses 20 are also distinguished from each other by the frequency or codes, for example. Similarly, a second wireless communication channel 30-2 and a second wireless communication channel 30-2 for different wireless child station apparatuses 20 are also distinguished from each other by frequency or codes. Thus, the 2n wireless communication channels 30 illustrated in FIG. 1 are recognized as different communication channels by the wireless parent station apparatus 10.

Each of the wireless child station apparatuses 20 transmits connection check request data to the wireless parent station apparatus 10 via one or both of the first wireless communication channel 30-1 and the second wireless communication channel 30-2. The connection check request data is data for checking a connection condition, such as a Keep-Alive message, for example.

The wireless parent station apparatus 10 transmits connection check response data through the first wireless communication channel 30-1 in response to connection check request data received through the first wireless communication channel 30-1. In addition, the wireless parent station apparatus 10 transmits connection check response data through the second wireless communication channel 30-2 in response to connection check request data received through the second wireless communication channel 30-2. Each of the wireless child station apparatuses 20 receives connection check response data through the first wireless communication channel 30-1 and the second wireless communication channel 30-2.

Note that the wireless child station apparatus 20 corresponds to an example of wireless communication apparatus. In addition, the wireless parent station apparatus 10 corresponds to an example of a communication destination apparatus.

In addition, operation performed by the wireless child station apparatus 20 corresponds to an example of a wireless communication method and a wireless communication program.

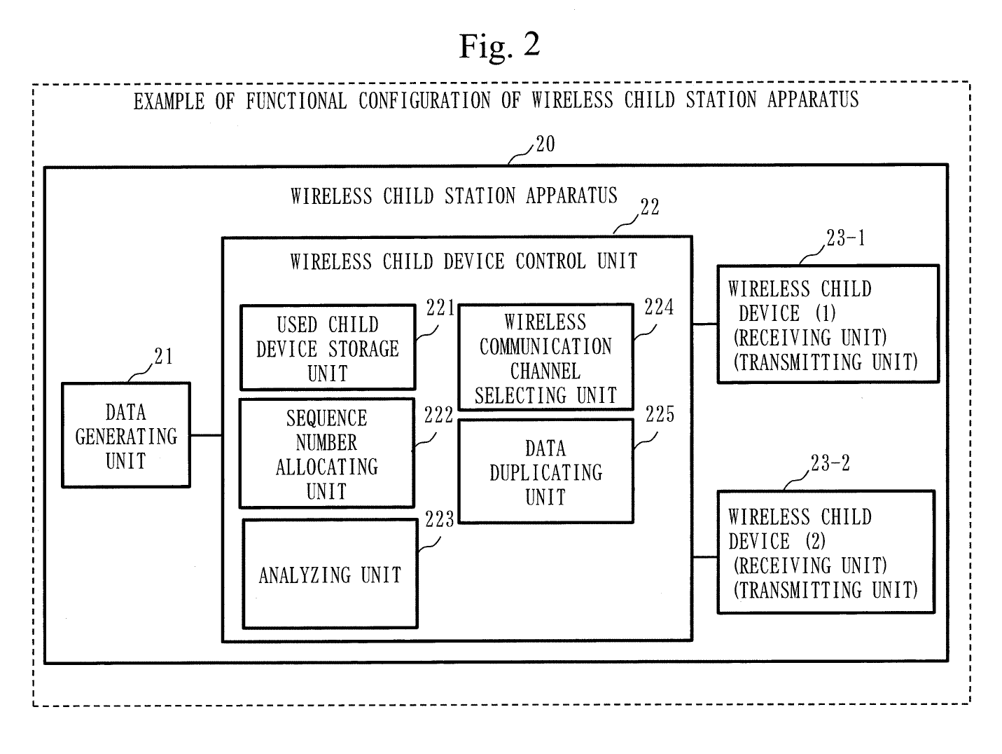

FIG. 2 illustrates an example of a functional configuration of a wireless child station apparatus 20. As illustrated in FIG. 2, the wireless child station apparatus 20 includes a data generating unit 21, a wireless child device control unit 22, a wireless child device (1) 23-1, and a wireless child device (2) 23-2.

Furthermore, the wireless child device control unit 22 includes a used child device storage unit 221, a sequence number allocating unit 222, an analyzing unit 223, a wireless communication channel selecting unit 224, and a data duplicating unit 225.

Details of the respective components illustrated in FIG. 2 will be described later.

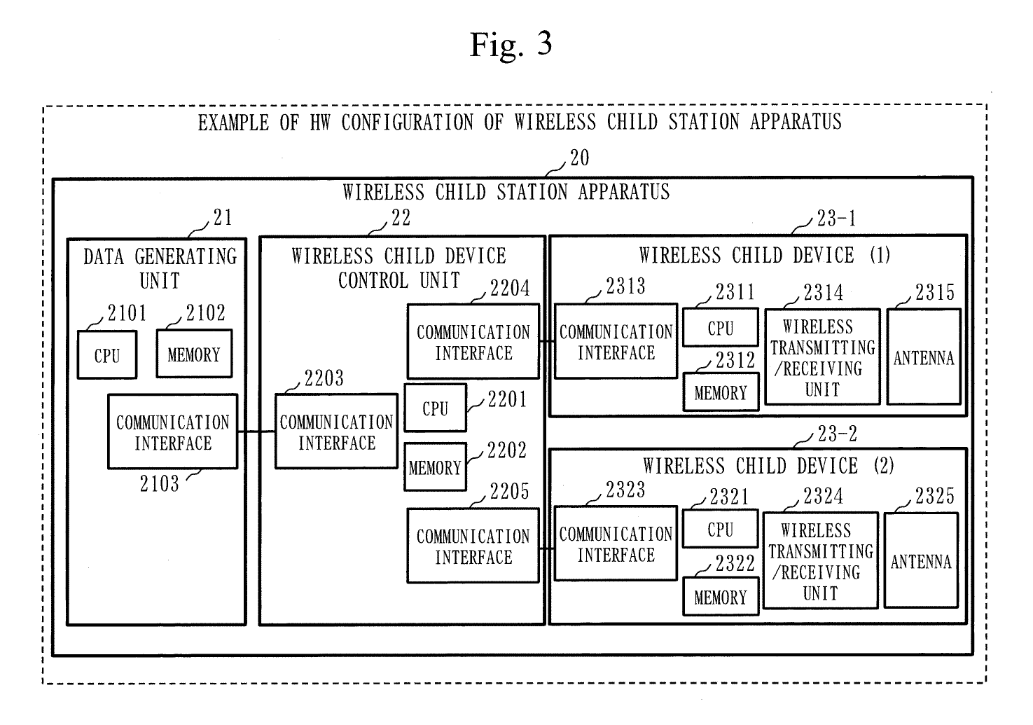

FIG. 3 illustrates an example of a hardware configuration of the wireless child station apparatus 20.

The data generating unit 21 is constituted by a central processing unit (CPU) 2101, a memory 2102, and a communication interface 2103. The wireless child device control unit 22 is constituted by a CPU 2201, a memory 2202, a communication interface 2203, a communication interface 2204, and a communication interface 2205. The wireless child device (1) 23-1 is constituted by a CPU 2311, a memory 2312, a communication interface 2313, a wireless transmitting/receiving unit 2314, and an antenna 2315. The wireless child device (2) 23-2 is constituted by a CPU 2321, a memory 2322, a communication interface 2323, a wireless transmitting/receiving unit 2324, and an antenna 2325.

The CPU 2101, the CPU 2201, the CPU 2311, and the CPU 2321 are processors that perform various arithmetic operations. In addition, the CPU 2101, the CPU 2201, the CPU 2311, and the CPU 2321 execute programs. Specifically, the CPU 2101 executes programs for implementing the functions of the data generating unit 21. In addition, the CPU 2311 executes programs for implementing the functions of the wireless child device (1) 23-1. In addition, the CPU 2321 executes programs for implementing the functions of the wireless child device (2) 23-2. Furthermore, the CPU 2201 executes programs for implementing the functions of the wireless child device control unit 22. More specifically, the CPU 2201 executes programs for implementing the functions of the sequence number allocating unit 222, the analyzing unit 223, the wireless communication channel selecting unit 224, and the data duplicating unit 225 illustrated in FIG. 2. In other words, the functions of the sequence number allocating unit 222, the analyzing unit 223, the wireless communication channel selecting unit 224, and the data duplicating unit 225 are implemented by programs.

The memory 2102, the memory 2202, the memory 2312, and the memory 2322 are random access memories (RAMs), read only memories (ROMs), flash memories, hard disk drives (HDDs), or the like. The memory 2102, the memory 2202, the memory 2312, and the memory 2322 store operands and results of arithmetic operation of the CPU 2101, the CPU 2201, the CPU 2311, and the CPU 2321. The memory 2102, the memory 2202, the memory 2312, and the memory 2322 also store programs to be executed by the CPU 2101, the CPU 2201, the CPU 2311, and the CPU 2321. The communication interface 2103, the communication interface 2203, the communication interface 2204, the communication interface 2205, the communication interface 2313, and the communication interface 2323 are interface circuits for communication with other components. Specifically, the communication interface 2103 and the communication interface 2203 communicate with each other. The communication interface 2204 and the communication interface 2313 communicate with each other. The communication interface 2205 and the communication interface 2323 communicate with each other. Communication between the respective components is performed using Ethernet (registered trademark), for example.

The wireless transmitting/receiving unit 2314 and the wireless transmitting/receiving unit 2324 are circuits that process data to be transmitted to the wireless parent station apparatus 10 and data received from the wireless parent station apparatus 10. The antenna 2315 and the antenna 2325 are antennas that transmit and receive wireless waves.

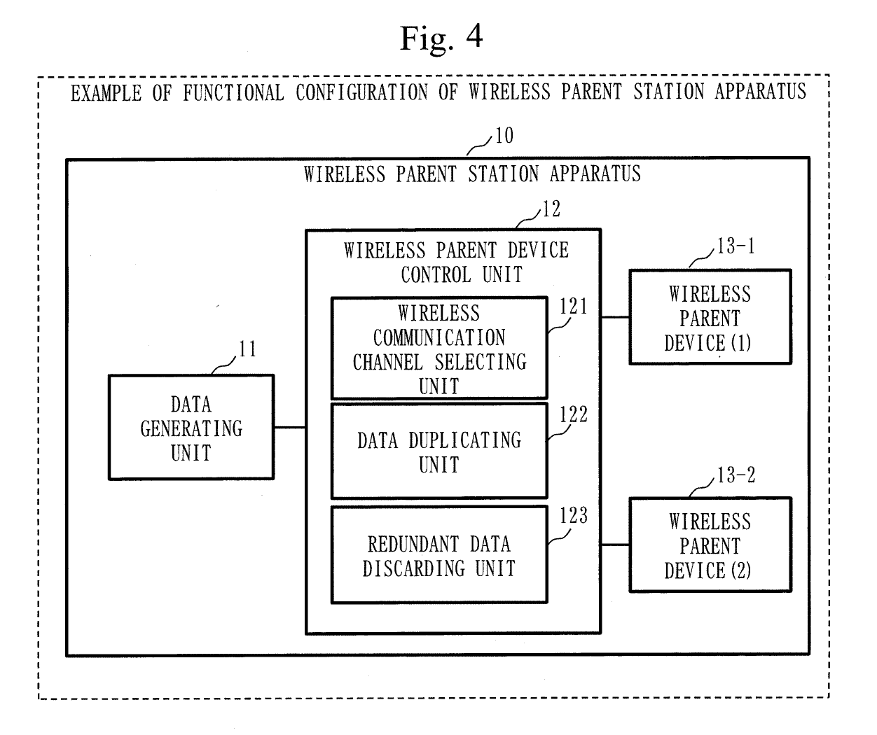

FIG. 4 illustrates an example of a functional configuration of the wireless parent station apparatus 10.

As illustrated in FIG. 4, the wireless parent station apparatus 10 includes a data generating unit 11, a wireless parent device control unit 12, a wireless parent device (1) 13-1, and a wireless parent device (2) 13-2. Furthermore, the wireless parent device control unit 12 includes a wireless communication channel selecting unit 121, a data duplicating unit 122, and a redundant data discarding unit 123. Details of the respective components illustrated in FIG. 4 will be described later.

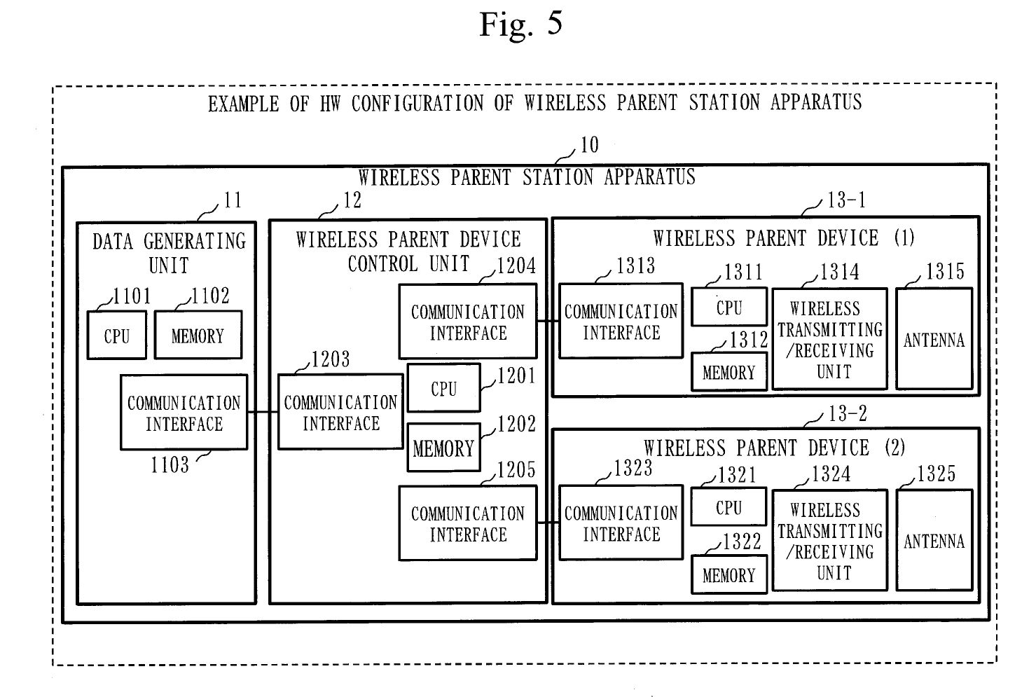

FIG. 5 illustrates an example of a hardware configuration of the wireless parent station apparatus 10.

A CPU 1101, a CPU 1201, a CPU 1311, and a CPU 1321 are processors that perform various arithmetic operations. In addition, the CPU 1101, the CPU 1201, the CPU 1311, and the CPU 1321 execute programs. Specifically, the CPU 1101 executes programs for implementing the functions of the data generating unit 11. In addition, the CPU 1311 executes programs for implementing the functions of the wireless parent device (1) 13-1. In addition, the CPU 1321 executes programs for implementing the functions of the wireless parent device (2) 13-2. Furthermore, the CPU 1201 executes programs for implementing the functions of the wireless parent device control unit 12. More specifically, the CPU 1201 executes programs for implementing the functions of the wireless communication channel selecting unit 121, the data duplicating unit 122, and the redundant data discarding unit 123 illustrated in FIG. 4. In other words, the functions of the wireless communication channel selecting unit 121, the data duplicating unit 122, and the redundant data discarding unit 123 are implemented by programs.

The memory 1102, the memory 1202, the memory 1312, and the memory 1322 are RAMs, flash memories, HDDs, or the like. The memory 1102, the memory 1202, the memory 1312, and the memory 1322 store operands and results of arithmetic operations of the CPU 1101, the CPU 1201, the CPU 1311, and the CPU 1321. The memory 1102, the memory 1202, the memory 1312, and the memory 1322 also store programs to be executed by the CPU 1101, the CPU 1201, the CPU 1311, and the CPU 1321.

The communication interface 1103, the communication interface 1203, the communication interface 1204, the communication interface 1205, the communication interface 1313, the communication interface 1323 are interface circuits for communication with other components. Specifically, the communication interface 1103 and the communication interface 1203 communicate with each other. The communication interface 1204 and the communication interface 1313 communicate with each other. The communication interface 1205 and the communication interface 1323 communicate with each other. Communication between the respective components is performed using Ethernet, for example.

The wireless transmitting/receiving unit 1314 and the wireless transmitting/receiving unit 1324 are circuits that process data to be transmitted to the wireless child station apparatuses 20 and data received from the wireless child station apparatuses 20.

The antenna 1315 and the antenna 1325 are antennas that transmit and receive wireless waves.

***Description of Operation***

Next, example operations of the respective components of the wireless child station apparatus 20 illustrated in FIG. 2 will be described.

The data generating unit 21 generates data. More specifically, the data generating unit 21 generates connection check request data and user data. Note that the data generating unit 21 may receive connection check request data or user data from an external device other than the wireless parent station apparatus 10 instead of generating the connection check request data or user data.

The user data is data to be transmitted to and received from the wireless parent station apparatus 10 and the wireless child station apparatuses 20 in addition to the connection check request data and the connection check response data. What data is transmitted and received as the user data depends on the attributes of the wireless communication system.

The wireless child device (1) 23-1 is connected with the first wireless communication channel 30-1. When the first wireless communication channel 30-1 is selected by the wireless communication channel selecting unit 224, which will be described later, the wireless child device (1) 23-1 transmits connection check request data or user data to the wireless parent station apparatus 10 through the first wireless communication channel 30-1. The wireless child device (1) 23-1 also receives connection request response data through the first wireless communication channel 30-1 in response to connection check request data transmitted to the wireless parent station apparatus 10 through the first wireless communication channel 30-1.

The wireless child device (2) 23-2 is connected with the second wireless communication channel 30-2. When the second wireless communication channel 30-2 is selected by the wireless communication channel selecting unit 224, which will be described later, the wireless child device (2) 23-2 transmits connection check request data or user data to the wireless parent station apparatus 10 through the second wireless communication channel 30-2. The wireless child device (2) 23-2 also receives connection request response data through the second wireless communication channel 30-2 in response to connection check request data transmitted to the wireless parent station apparatus 10 through the second wireless communication channel 30-2.

The wireless child device (1) 23-1 and the wireless child device (2) 23-2 correspond to examples of a receiving unit and a transmitting unit. In addition, operations of the wireless child device (1) 23-1 and the wireless child device (2) 23-2 correspond to examples of a reception process and a transmission process.

In the wireless child device control unit 22, the used child device storage unit 221 stores an identifier of a wireless child device that has been used most recently for communication with the wireless parent station apparatus 10. Specifically, when the wireless child device that has been used for the most recent communication with the wireless parent station apparatus 10 is the wireless child device (1) 23-1, the identifier of the wireless child device (1) 23-1 is stored in the used child device storage unit 221. In contrast, when the wireless child device that has been used for the most recent communication with the wireless parent station apparatus 10 is the wireless child device (2) 23-2, the identifier of the wireless child device (2) 23-2 is stored in the used child device storage unit 221. The used child device storage unit 221 is realized by the memory 2202 illustrated in FIG. 3.

The sequence number allocating unit 222 allocates sequence numbers to data generated by the data generating unit 21.

The analyzing unit 223 analyzes the condition of reception of connection check response data of each of the wireless communication channels 30. More specifically, the analyzing unit 223 calculates a reception ratio of connection check response data to connection check request data of each of the wireless communication channels 30 as analysis of the condition of reception of connection check response data.

The operation of the analyzing unit 223 corresponds to an example of an analysis process.

The wireless communication channel selecting unit 224 selects a wireless communication channel 30 through which connection check request data is to be transmitted, from among a plurality of wireless communication channels 30, on the basis of a result of analysis of the analyzing unit 223. More specifically, when the reception ratios of the wireless communication channels 30 are smaller than a threshold, the wireless communication channel selecting unit 224 selects all of the wireless communication channels 30. When the reception ratios of the wireless communication channels 30 are not smaller than the threshold and are of the same level, the wireless communication channel selecting unit 224 selects a wireless communication channel 30 through which connection check request data is to be transmitted, alternately, from among the wireless communication channels 30. When the reception ratio of any of the wireless communication channels 30 is not smaller than the threshold and the reception ratios of the wireless communication channels 30 are not of the same level, the wireless communication channel selecting unit 224 selects with priority the wireless communication channel 30 with a higher reception ratio.

Furthermore, when transmission of user data to the wireless parent station apparatus 10 is requested by the data generating unit 21, the wireless communication channel selecting unit 224 selects a wireless communication channel 30 through which the user data is to be transmitted, on the basis of a result of analysis of the analyzing unit 223. More specifically, when the reception ratios of connection check response data of the wireless communication channels 30 are smaller than the threshold, the wireless communication channel selecting unit 224 selects a plurality of wireless communication channels 30. When the reception ratio of any of the wireless communication channels 30 is not smaller than the threshold, the wireless communication channel selecting unit 224 determines whether or not connection check response data is received after transmission of user data is requested by the data generating unit 21, and selects a wireless communication channel through which the user data is to be transmitted, on the basis of the result of determination. More specifically, when connection check response data is received after transmission of user data is requested by the data generating unit 21, the wireless communication channel selecting unit 224 selects the wireless communication channel 30 through which the connection check response data is received. In contrast, when no connection check response data is received after transmission of user data is requested by the data generating unit 21, the wireless communication channel selecting unit 224 selects a wireless communication channels 30 (a wireless communication channel 30 corresponding to the wireless child device stored in the used child device storage unit 221) through which the connection check response data is last received before transmission of user data is requested.

The operation of the wireless communication channel selecting unit 224 corresponds to an example of a wireless channel selection process.

The data duplicating unit 225 duplicates connection check request data or user data. When the wireless communication channel selecting unit 224 selects to transmit connection check request data through both of the first wireless communication channel 30-1 and the second wireless communication channel 30-2, the data duplicating unit 225 duplicates the connection check request data.

Similarly, when the wireless communication channel selecting unit 224 selects to transmit user data through both of the first wireless communication channel 30-1 and the second wireless communication channel 30-2, the data duplicating unit 225 duplicates the user data.

Next, operations of the respective components of the wireless parent station apparatus 10 illustrated in FIG. 4 will be described.

The data generating unit 11 generates data. More specifically, data generating unit 11 generates connection check response data.

The wireless parent device (1) 13-1 is connected with the first wireless communication channels 30-1. The wireless parent device (1) 13-1 receives connection check request data through a first wireless communication channel 30-1, and transmits connection check response data through the first wireless communication channel 30-1 to the wireless child station apparatus 20 from which the connection check request data have been transmitted. The wireless parent device (1) 13-1 also receives user data through a first wireless communication channel 30-1.

The wireless parent device (2) 13-2 is connected with the second wireless communication channels 30-2. The wireless parent device (2) 13-2 receives connection check request data through a second wireless communication channel 30-2, and transmits connection check response data through the second wireless communication channel 30-2 to the wireless child station apparatus 20 from which the connection check request data have been transmitted. The wireless parent device (2) 13-2 also receives user data through a second wireless communication channel 30-2.

In the wireless parent device control unit 12, the wireless communication channel selecting unit 121 selects a wireless communication channel 30 through which connection check response data is to be transmitted. More specifically, the wireless communication channel selecting unit 121 selects the wireless communication channel 30 used for reception of the connection check request data, as the wireless communication channel 30 through which connection check response data is to be transmitted. Specifically, the wireless communication channel selecting unit 121 selects the first wireless communication channel 30-1 for connection check response data in response to the connection check request data received through the first wireless communication channel 30-1. In addition, the wireless communication channel selecting unit 121 selects the second wireless communication channel 30-2 for connection check response data in response to the connection check request data received through the second wireless communication channel 30-2.

The data duplicating unit 122 duplicates connection check response data. When the wireless communication channel selecting unit 121 selects to transmit connection request response data through both of the first wireless communication channel 30-1 and the second wireless communication channel 30-2, the data duplicating unit 122 duplicates the connection check response data.

When user data of the same sequence number are redundantly received through the first wireless communication channel 30-1 and the second wireless communication channel 30-2, the redundant data discarding unit 123 discards one of the user data.

Next, a method for reducing communication traffic of connection check request data and connection check response data will be explained.

In each of the wireless child station apparatuses 20, the data generating unit 21 generates connection check request data at regular intervals (intervals of any of 0.1 to 0.5 seconds, for example). Each time connection check request data is generated by the data generating unit 21, the generated connection check request data is transmitted from either one of the wireless child device (1) 23-1 and the wireless child device (2) 23-2 or both of the wireless child device (1) 23-1 and the wireless child device (2) 23-2. Specifically, the connection check request data is transmitted through either one of the first wireless communication channel 30-1 and the second wireless communication channel 30-2 or both of the first wireless communication channel 30-1 and the second wireless communication channel 30-2.

Upon receiving connection check request data, the wireless parent station apparatus 10 transmits connection check response data through the wireless communication channel 30 through which the connection check request data have been received. When connection check request data have been received only through the first wireless communication channel 30-1, the wireless parent station apparatus 10 transmits connection check response data only through the first wireless communication channel 30-1. When connection check request data have been received only through the second wireless communication channel 30-2, the wireless parent station apparatus 10 transmits connection check response data only through the second wireless communication channel 30-2. When connection check request data have been received through both of the first wireless communication channel 30-1 and the second wireless communication channel 30-2, the wireless parent station apparatus 10 transmits connection check response data through both of the first wireless communication channel 30-1 and the second wireless communication channel 30-2.

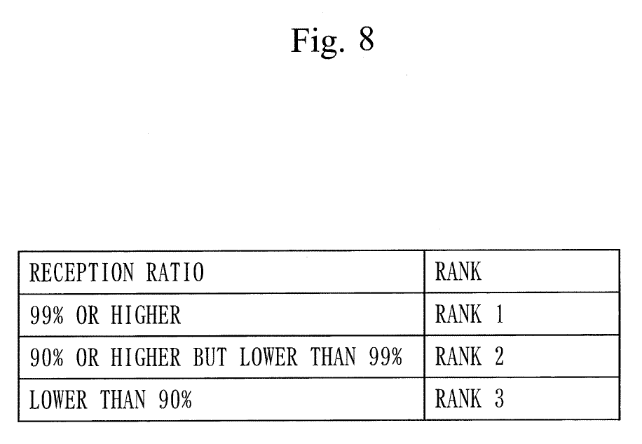

In each of the wireless child station apparatuses 20, the analyzing unit 223 calculates a reception ratio of connection check response data to connection check request data of each of the wireless communication channels 30. The reception ratios are ranked according to a rank table illustrated in FIG. 8. For example, when connection check response data are received at a ratio of 99% or higher in response to connection check request data transmitted through the first wireless communication channel 30-1, the first wireless communication channel 30-1 is ranked as rank 1.

The wireless communication channel selecting unit 224 determines a transmission schedule of connection check request data on the basis of the ranks of the respective wireless communication channels 30. The wireless communication channel selecting unit 224 determines, as the transmission schedule, whether to transmit connection check request data through either one of the first wireless communication channel 30-1 and the second wireless communication channel 30-2 or through both of the first wireless communication channel 30-1 and the second wireless communication channel 30-2. Furthermore, when connection check request data is to be transmitted through either one of the first wireless communication channel 30-1 and the second wireless communication channel 30-2, the wireless communication channel selecting unit 224 determines, as the transmission schedule, a transmission ratio of the first wireless communication channel 30-1 and the second wireless communication channel 30-2 on the basis of the ranks of the respective wireless communication channels 30.

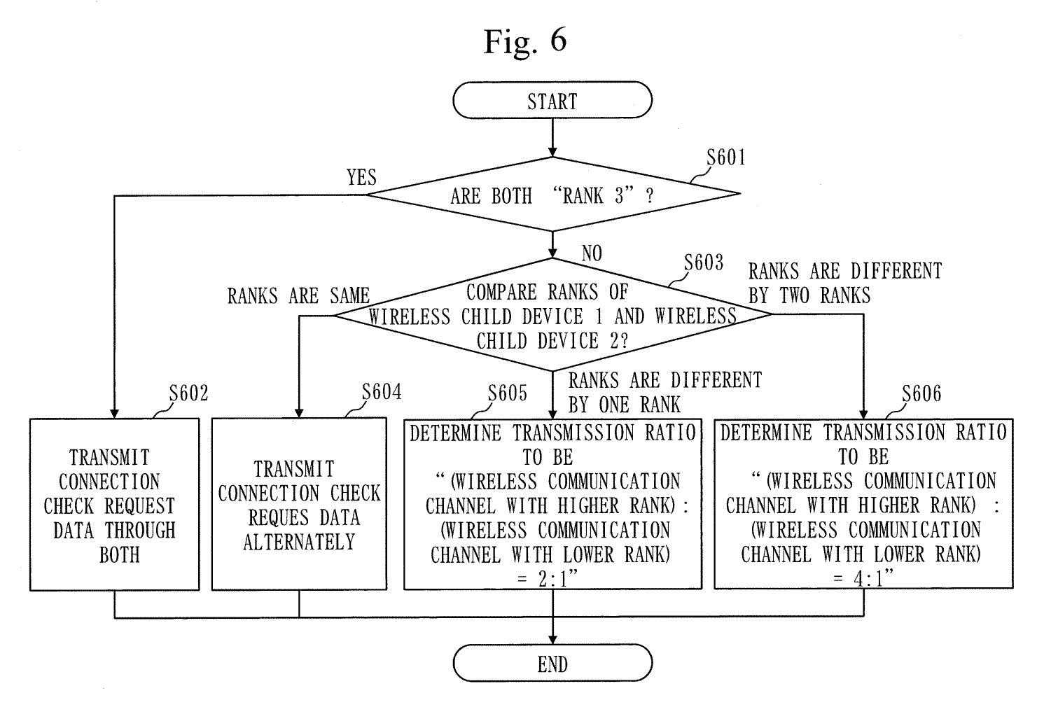

Next, a procedure for determining a transmission schedule of connection check request data by the wireless communication channel selecting unit 224 of each of the wireless child station apparatuses 20 will be explained with reference to FIG. 6.

The wireless communication channel selecting unit 224 may start the procedure of FIG. 6 at regular intervals or may start the procedure of FIG. 6 when a change in the rank of either of the wireless communication channels 30 has occurred.

Note that there assumed to be three ranks for the wireless communication channels 30, which are rank 1 to rank 3, below as illustrated in FIG. 8.

The wireless communication channel selecting unit 224 determines whether or not the rank of the first wireless communication channel 30-1 and that of the second wireless communication channel 30-2 are both “rank 3” (step S601).

Specifically, the wireless communication channel selecting unit 224 refers to the analyzing unit 223 for the rank of the first wireless communication channel 30-1 and the rank of the second wireless communication channel 30-2, and determines whether or not the ranks of the first wireless communication channel 30-1 and the second wireless communication channel 30-2 are both “rank 3.”

If the ranks of the first wireless communication channel 30-1 and the second wireless communication channel 30-2 are both “rank 3” (YES in step S601), the wireless communication channel selecting unit 224 determines to transmit connection check request data through both of the first wireless communication channel 30-1 and the second wireless communication channel 30-2 (step S602).

Specifically, in this example, the wireless communication channel selecting unit 224 uses “rank 2” as the threshold and, when the ranks of the first wireless communication channel 30-1 and the second wireless communication channel 30-2 are both lower than the “rank 2” that is the threshold, determines to transmit connection check request data through both of the first wireless communication channel 30-1 and the second wireless communication channel 30-2.

If at least either of the ranks of the first wireless communication channel 30-1 and the second wireless communication channel 30-2 is not “rank 3” (NO in step S601), the wireless communication channel selecting unit 224 compares the rank of the first wireless communication channel 30-1 with the rank of the second wireless communication channel 30-2 (step S603).

If the ranks of the first wireless communication channel 30-1 and the second wireless communication channels 30-2 are the same, the wireless communication channel selecting unit 224 determines to transmit connection check request data alternately through the first wireless communication channel 30-1 and through the second wireless communication channel 30-2 (step S604). Specifically, the wireless communication channel selecting unit 224 determines to transmit connection check request data at a transmission ratio of “(first wireless communication channel 30-1):(second wireless communication channel 30-2)=1:1.”

If the ranks of the first wireless communication channel 30-1 and the second wireless communication channel 30-2 are different from each other by one rank, the wireless communication channel selecting unit 224 determines to transmit connection check request data at a transmission ratio of “(wireless communication channel with higher rank): (wireless communication channel with lower rank)=2:1” (step S605). For example, when the rank of the first wireless communication channel 30-1 is higher, the number of times connection check request data is transmitted through the first wireless communication channel 30-1 is twice the number of times connection check request data are transmitted through the second wireless communication channel 30-2.

In addition, if the ranks of the first wireless communication channel 30-1 and the second wireless communication channel 30-2 are different from each other by two ranks, the wireless communication channel selecting unit 224 determines to transmit connection check request data at a transmission ratio of “(wireless communication channel with higher rank): (wireless communication channel with lower rank)=4:1” (step S605). For example, when the rank of the first wireless communication channel 30-1 is higher, the number of times connection check request data is transmitted through the first wireless communication channel 30-1 is four times the number of times connection check request data is transmitted through the second wireless communication channel 30-2.

As described above, when the ranks of the first wireless communication channel 30-1 and the second wireless communication channel 30-2 are not the same, the wireless communication channel selecting unit 224 selects with priority a wireless communication channel 30 with a higher rank. In addition, the wireless communication channel selecting unit 224 increases the gradient of the transmission ratio according to the difference between the ranks of the first wireless communication channel 30-1 and the second wireless communication channel 30-2.

Each time connection check request data is generated by the data generating unit 21, the wireless communication channel selecting unit 224 acquires the newly generated connection check request data from the data generating unit 21.

When the wireless communication channel selecting unit 224 has determined on the transmission schedule of step S602, the wireless communication channel selecting unit 224 outputs the newly generated connection check request data to the data duplicating unit 225. The data duplicating unit 225 duplicates the connection check request data, and the sequence number allocating unit 222 allocates the same sequence number to the two connection check request data. The data duplicating unit 225 then outputs the two connection check request data to the wireless child device (1) 23-1 and the wireless child device (2) 23-2. The wireless child device (1) 23-1 transmits one of the connection check request data to the wireless parent station apparatus 10 through the first wireless communication channel 30-1, and the wireless child device (2) 23-2 transmits the other of the connection check request data to the wireless parent station apparatus 10 through the second wireless communication channel 30-2.

In addition, when the wireless communication channel selecting unit 224 has determined on the transmission schedule of any one of steps S604, S605, and S606, the wireless communication channel selecting unit 224 outputs the connection request data to which a sequence number is allocated by the sequence number allocating unit 222 to the relevant wireless child device.

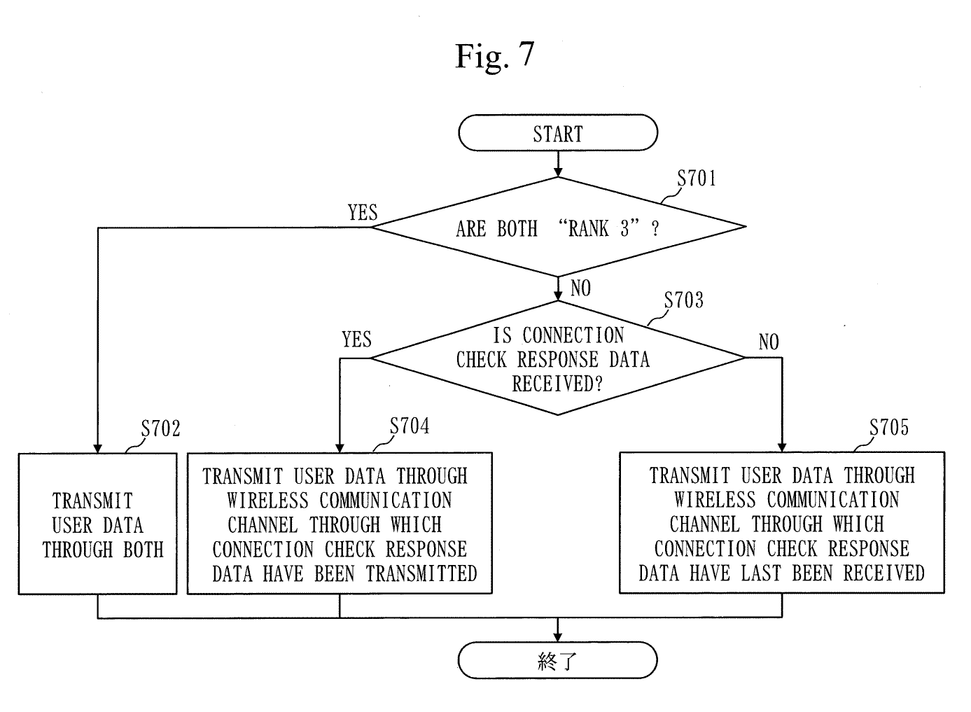

Next, example operation of the wireless communication channel selecting unit 224 in transmission of user data will be explained with reference to FIG. 7.

The procedure of FIG. 7 is started when user data is generated by the data generating unit 21.

Note that there assumed to be three ranks for the wireless communication channels 30, which are rank 1 to rank 3, below as illustrated in FIG. 8.

The wireless communication channel selecting unit 224 determines whether or not the rank of the first wireless communication channel 30-1 and that of the second wireless communication channel 30-2 are both “rank 3” (step S701).

Specifically, the wireless communication channel selecting unit 224 refers to the analyzing unit 223 for the rank of the first wireless communication channel 30-1 and the rank of the second wireless communication channel 30-2, and determines whether or not the ranks of the first wireless communication channel 30-1 and the second wireless communication channel 30-2 are both “rank 3.”

If the ranks of the first wireless communication channel 30-1 and the second wireless communication channel 30-2 are both “rank 3” (YES in step S701), the wireless communication channel selecting unit 224 determines to transmit user data through both of the first wireless communication channel 30-1 and the second wireless communication channel 30-2 (step S702).

Specifically, in this example, the wireless communication channel selecting unit 224 uses “rank 2” as the threshold and, when the ranks of the first wireless communication channel 30-1 and the second wireless communication channel 30-2 are both lower than the “rank 2” that is the threshold, determines to transmit user data through both of the first wireless communication channel 30-1 and the second wireless communication channel 30-2.

If at least either of the ranks of the first wireless communication channel 30-1 and the second wireless communication channel 30-2 is not “rank 3” (NO in step S701), the wireless communication channel selecting unit 224 determines whether or not connection check response data is received after user data is generated by the data generating unit 21, that is, after transmission of the user data is requested by the data generating unit 21 (step S703).

As described above, since the transmission period of the connection check request data comes at intervals of any of 0.1 to 0.5 seconds, connection check response data is likely to be received after generation of user data by the data generating unit 21 and before transmission of the user data.

If connection check response data is received after user data is generated by the data generating unit 21 (YES in step S703), the wireless communication channel selecting unit 224 determines to transmit the user data through the wireless communication channel 30 through which the connection check response data have been received (step S704).

For example, if connection check response data is received through the first wireless communication channel 30-1 after user data is generated by the data generating unit 21, the wireless communication channel selecting unit 224 determines to transmit the user data through the first wireless communication channel 30-1.

When the connection check response data is received through the first wireless communication channel 30-1, the first wireless communication channel 30-1 is known to effectively function, and thus the wireless communication channel selecting unit 224 selects the first wireless communication channel 30-1.

In contrast, if the connection check response data is not received after user data is generated (NO in step S703), the wireless communication channel selecting unit 224 determines to transmit the user data through the wireless communication channel 30 through which the connection check response data is last received before generation of the user data (step S705).

For example, if the wireless communication channel 30 through which connection check response data is last received before user data is generated by the data generating unit 21 is the second wireless communication channel 30-2, the wireless communication channel selecting unit 224 determines to transmit the user data through the second wireless communication channel 30-2.

The second wireless communication channel 30-2 is known to effectively function at the point when the connection check response data is received, and it is likely that the second wireless communication channel 30-2 also functions effectively at present. The wireless communication channel selecting unit 224 thus selects the second wireless communication channel 30-2.

Note that the wireless communication channel selecting unit 224 can recognize the wireless child device that has received the connection check response data before generation of the user data by referring to the used child device storage unit 221, and as a result, the wireless communication channel selecting unit 224 can recognize the wireless communication channel 30 through which the connection check response data have been received.

Each time user data is generated by the data generating unit 21, the wireless communication channel selecting unit 224 acquires the newly generated user data from the data generating unit 21.

In addition, when the wireless communication channel selecting unit 224 determines to transmit the user data through both of the first wireless communication channel 30-1 and the second wireless communication channel 30-2 in step S702, the wireless communication channel selecting unit 224 outputs the user data to the data duplicating unit 225. The data duplicating unit 225 duplicates the user data, and the sequence number allocating unit 222 allocates the same sequence number to the two user data. The data duplicating unit 225 then outputs the two user data to the wireless child device (1) 23-1 and the wireless child device (2) 23-2. The wireless child device (1) 23-1 transmits one of the user data to the wireless parent station apparatus 10 through the first wireless communication channel 30-1, and the wireless child device (2) 23-2 transmits the other of the user data to the wireless parent station apparatus 10 through the second wireless communication channel 30-2.

In the wireless parent station apparatus 10, when user data with the same sequence number are received through the first wireless communication channel 30-1 and the second wireless communication channel 30-2, the redundant data discarding unit 123 discards the latterly received user data.

In contrast, when the wireless communication channel selecting unit 224 has selected either one wireless communication channel 30 of the first wireless communication channel 30-1 and the second wireless communication channel 30-2 in step S704 or S705, the wireless communication channel selecting unit 224 outputs the user data to which a sequence number is allocated by the sequence number allocating unit 222 to the relevant wireless child device.

### Description of Effects of Embodiment

As described above, according to the present embodiment, the wireless communication channels through which connection check request data and user data is to be transmitted are determined on the basis of the condition of reception of connection check response data, therefore, consumption of communication bands by redundant user data can be reduced without lowering the data arrival rate.

Thus, according to the present embodiment, connection check request data and user data can be transmitted only through appropriate wireless communication channels depending on the condition of reception of connection check response data, therefore, the frequency efficiency can be improved.

### Second Embodiment

In the first embodiment, an example in which two wireless communication channels 30, which are the first wireless communication channel 30-1 and the second wireless communication channel 30-2, are set between the wireless parent station apparatus 10 and each of the wireless child station apparatuses 20 is explained.

In the present embodiment, example operation of the wireless communication channel selecting unit 224 in a case where three or more wireless communication channels 30 are set between the wireless parent station apparatus 10 and each of the wireless child station apparatuses 20 will be explained.

Note that differences from the first embodiment will mainly be described. The matters not described below are the same as those in the first embodiment.

An example system configuration of a communication system according to the present embodiment is as illustrated in FIG. 1.

Three or more wireless communication channels 30, however, are set between the wireless parent station apparatus 10 and each of the wireless child station apparatuses 20. Note that, in the following, for concise description, assume that three wireless communication channels 30 are set between the wireless parent station apparatus 10 and each of the wireless child station apparatuses 20. In the description below, wireless communication channels 30 provided in addition to the first wireless communication channels 30-1 and the second wireless communication channels 30-2 illustrated in FIG. 1 will be referred to as third wireless communication channels 30-3.

In addition, the functional configuration and the hardware configuration of the wireless child station apparatuses 20 according to the present embodiment are basically the same as those illustrated in FIGS. 2 and 3, but three wireless child devices are provided in each of the wireless child station apparatuses 20 according to the present embodiment. In the description below, a wireless child device provided in addition to the wireless child device (1) 23-1 and the wireless child device (2) 23-2 illustrated in FIGS. 2 and 3 will be referred to as a wireless child device (3) 23-3. Specifically, the wireless child device (3) 23-3 is connected with the third wireless communication channel 30-3, and transmits connection check request data or user data to the wireless parent station apparatus 10 through the third wireless communication channel 30-3. The wireless child device (3) 23-3 also receives connection request response data through the third wireless communication channel 30-3 in response to connection check request data transmitted to the wireless parent station apparatus 10 through the third wireless communication channel 30-3.

Note that, in the present embodiment, the analyzing unit 223 also calculates a reception ratio of connection check response data of the third wireless communication channel 30-3.

In addition, the functional configuration and the hardware configuration of the wireless parent station apparatus 10 according to the present embodiment are basically the same as those illustrated in FIGS. 4 and 5, but three wireless parent devices are provided in the wireless parent station apparatus 10 according to the present embodiment. In the description below, a wireless child device provided in addition to the wireless parent device (1) 13-1 and the wireless parent device (2) 13-2 illustrated in FIGS. 4 and 5 will be referred to as a wireless parent device (3)13-3.

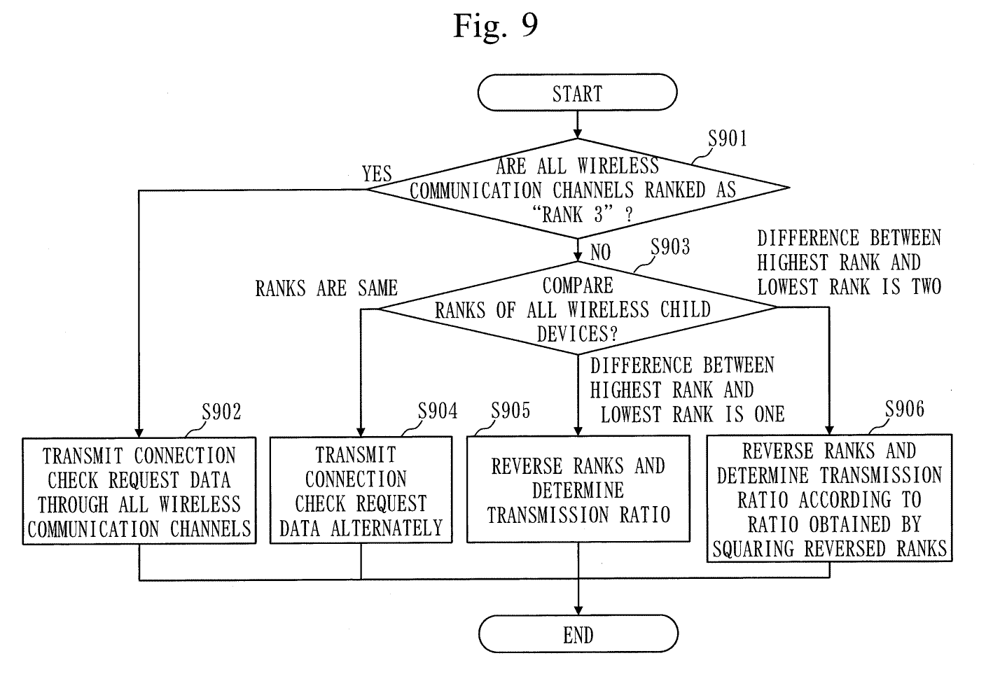

Next, a procedure for determining a transmission schedule of connection check request data by the wireless communication channel selecting unit 224 according to the present embodiment will be explained with reference to FIG. 9.

The wireless communication channel selecting unit 224 may start the procedure of FIG. 9 at regular intervals or may start the procedure of FIG. 9 when a change in the rank of either of the wireless communication channels 30 has occurred.

Note that there assumed to be three ranks for the wireless communication channels 30, which are rank 1 to rank 3, below as illustrated in FIG. 8.

The wireless communication channel selecting unit 224 determines whether or not the rank of the first wireless communication channel 30-1, the rank of the second wireless communication channel 30-2, and the rank of the third wireless communication channel 30-3 are all “rank 3” (step S901).

Specifically, the wireless communication channel selecting unit 224 refers to the analyzing unit 223 for the rank of the first wireless communication channel 30-1, the rank of the second wireless communication channel 30-2, and the rank of the third wireless communication channel 30-3 and determines whether or not the ranks of the first wireless communication channel 30-1, the second wireless communication channel 30-2, and the third wireless communication channel 30-3 are all “rank 3.”

If the ranks of the first wireless communication channel 30-1, the second wireless communication channel 30-2, and the third wireless communication channel 30-3 are all “rank 3” (YES in step S901), the wireless communication channel selecting unit 224 determines to transmit connection check request data through all of the first wireless communication channel 30-1, the second wireless communication channel 30-2, and the third wireless communication channel 30-3 (step S902).

Specifically, in this example, the wireless communication channel selecting unit 224 uses “rank 2” as a threshold and, when the ranks of the first wireless communication channel 30-1, the second wireless communication channel 30-2, and the third wireless communication channel 30-3 are all lower than “rank 2” that is the threshold, determines to transmit connection check request data through all of the first wireless communication channel 30-1, the second wireless communication channel 30-2, and the third wireless communication channel 30-3.

If at least any of the ranks of the first wireless communication channel 30-1, the second wireless communication channel 30-2, and the third wireless communication channel 30-3 is not “rank 3” (NO in step S901), the wireless communication channel selecting unit 224 compares the ranks of the first wireless communication channel 30-1, the second wireless communication channel 30-2, and the third wireless communication channel 30-3 (step S903).

If the ranks of the first wireless communication channel 30-1, the second wireless communication channel 30-2, and the third wireless communication channel 30-3 are all the same level, the wireless communication channel selecting unit 224 determines to transmit connection check request data alternately through the first wireless communication channel 30-1, the second wireless communication channel 30-2, and the third wireless communication channel 30-3 (step S904). Specifically, the wireless communication channel selecting unit 224 determines to transmit connection check request data at a transmission ratio of “(first wireless communication channel 30-1):(second wireless communication channel 30-2):(third wireless communication channel 30-3)=1:1:1.”

If the difference between the highest rank and the lowest rank of the ranks of the first wireless communication channel 30-1, the second wireless communication channel 30-2, and the third wireless communication channel 30-3 is one, the wireless communication channel selecting unit 224 determines the transmission ratio by reversing the highest rank and the lowest rank (step S905). For example, in a case where the rank of the first wireless communication channel 30-1 is “2,” the rank of the second wireless communication channel 30-2 is “1,” and the rank of the third wireless communication channel 30-3 is “1,” the wireless communication channel selecting unit 224 determines to transmit connection check request data at a transmission ratio of “(first wireless communication channel 30-1):(second wireless communication channel 30-2):(third wireless communication channel 30-3)=1:2:2” obtained by reversing “2” and “1.”

If the difference between the highest rank and the lowest rank of the ranks of the first wireless communication channel 30-1, the second wireless communication channel 30-2, and the third wireless communication channel 30-3 is two, the wireless communication channel selecting unit 224 determines the transmission ratio according to a ratio obtained by reversing the highest rank and the lowest rank and squaring reversed ranks (step S906). For example, in a case where the rank of the first wireless communication channel 30-1 is “3,” the rank of the second wireless communication channel 30-2 is “2,” and the rank of the third wireless communication channel 30-3 is “1,” the wireless communication channel selecting unit 224 reverses “3” and “1” and determines to transmit connection check request data at a transmission ratio of “(first wireless communication channel 30-1):(second wireless communication channel 30-2):(third wireless communication channel 30-3)=1:4:9” which corresponds to the square value of the reversed ranks.

Each time connection check request data is generated by the data generating unit 21, the wireless communication channel selecting unit 224 acquires the newly generated connection check request data from the data generating unit 21.

When the wireless communication channel selecting unit 224 has determined on the transmission schedule of step S902, the wireless communication channel selecting unit 224 outputs the newly generated connection check request data to the data duplicating unit 225. The data duplicating unit 225 duplicates the connection check request data, and the sequence number allocating unit 222 allocates the same sequence number to the three connection check request data. The data duplicating unit 225 then outputs the three connection check request data to the wireless child device (1) 23-1, the wireless child device (2) 23-2, and the wireless child device (3) 23-3. The wireless child device (1) 23-1 transmits the connection check request data to the wireless parent station apparatus 10 through the first wireless communication channel 30-1, the wireless child device (2) 23-2 transmits the connection check request data to the wireless parent station apparatus 10 through the second wireless communication channel 30-2, and the wireless child device (1) 23-1 transmits the connection check request data to the wireless parent station apparatus 10 through the third wireless communication channel 30-3.

In addition, when the wireless communication channel selecting unit 224 has determined on the transmission schedule of any one of steps S904, S905, and S906, the wireless communication channel selecting unit 224 outputs the connection request data to which a sequence number is allocated by the sequence number allocating unit 222 to the relevant wireless child device.

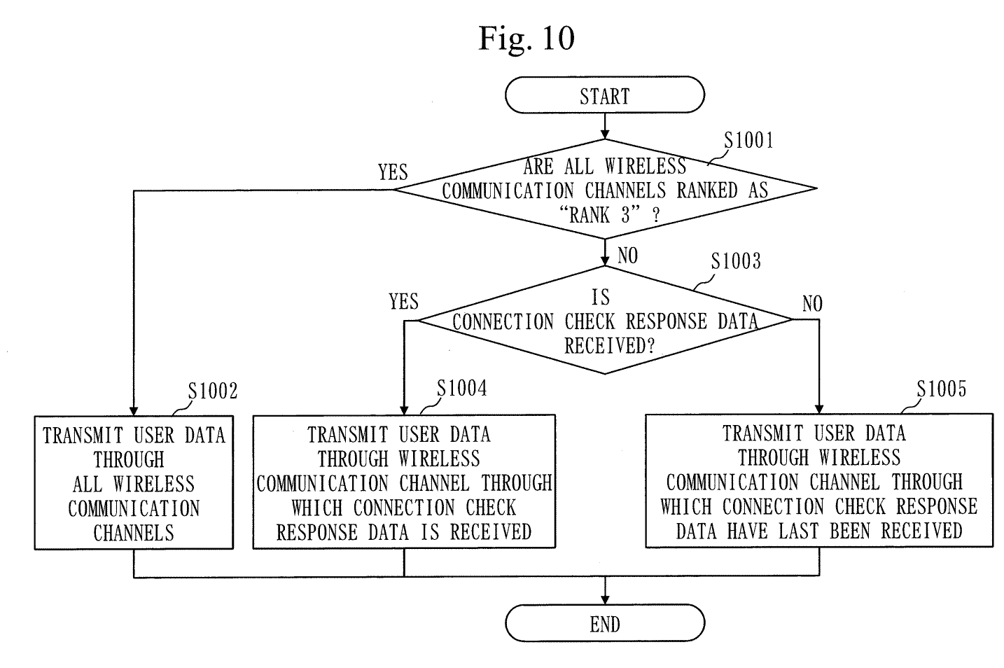

Next, example operation of the wireless communication channel selecting unit 224 in transmission of user data will be explained with reference to FIG. 10.

The procedure of FIG. 10 is started when user data is generated by the data generating unit 21.

Note that there assumed to be three ranks for the wireless communication channels 30, which are rank 1 to rank 3, below as illustrated in FIG. 8.

The wireless communication channel selecting unit 224 determines whether or not the rank of the first wireless communication channel 30-1, the rank of the second wireless communication channel 30-2, and the rank of the third wireless communication channel 30-3 are all “rank 3” (step S1001).

Specifically, the wireless communication channel selecting unit 224 refers to the analyzing unit 223 for the rank of the first wireless communication channel 30-1, the rank of the second wireless communication channel 30-2, and the rank of the third wireless communication channel 30-3 and determines whether or not the ranks of the first wireless communication channel 30-1, the second wireless communication channel 30-2, and the third wireless communication channel 30-3 are all “rank 3.”

If the ranks of the first wireless communication channel 30-1, the second wireless communication channel 30-2, and the third wireless communication channel 30-3 are all “rank 3” (YES in step S1001), the wireless communication channel selecting unit 224 determines to transmit user data through all of the ranks of the first wireless communication channel 30-1, the second wireless communication channel 30-2, and the third wireless communication channel 30-3 (step S1002).

Specifically, in this example, the wireless communication channel selecting unit 224 uses “rank 2” as a threshold and, when the ranks of the first wireless communication channel 30-1, the second wireless communication channel 30-2, and the third wireless communication channel 30-3 are all lower than “rank 2” that is the threshold, determines to transmit user data through all of the ranks of the first wireless communication channel 30-1, the second wireless communication channel 30-2, and the third wireless communication channel 30-3.

If at least any of the ranks of the first wireless communication channel 30-1, the second wireless communication channel 30-2, and the third wireless communication channel 30-3 is not “rank 3” (NO in step S1001), the wireless communication channel selecting unit 224 determines whether or not connection check response data is received after user data is generated by the data generating unit 21, that is, after transmission of the user data is requested by the data generating unit 21 (step S1003).

If connection check response data is received after user data is generated by the data generating unit 21 (YES in step S1003), the wireless communication channel selecting unit 224 determines to transmit the user data through the wireless communication channel 30 through which the connection check response data have been received (step S1004).

For example, if connection check response data is received through the first wireless communication channel 30-1 after user data is generated by the data generating unit 21, the wireless communication channel selecting unit 224 determines to transmit the user data through the first wireless communication channel 30-1.

When the connection check response data is received through the first wireless communication channel 30-1, the first wireless communication channel 30-1 is known to effectively function, and thus the wireless communication channel selecting unit 224 selects the first wireless communication channel 30-1.

In contrast, if the connection check response data is not received after user data is generated (NO in step S1003), the wireless communication channel selecting unit 224 determines to transmit the user data through the wireless communication channel 30 through which the connection check response data is last received before generation of the user data (step S1005).

For example, if the wireless communication channel 30 through which connection check response data is last received before user data is generated by the data generating unit 21 is the second wireless communication channel 30-2, the wireless communication channel selecting unit 224 determines to transmit the user data through the second wireless communication channel 30-2.

The second wireless communication channel 30-2 is known to effectively function as a communication channel at the point when the connection check response data is received, and it is likely that the second wireless communication channel 30-2 also functions effectively at present. The wireless communication channel selecting unit 224 thus selects the second wireless communication channel 30-2.

Note that the wireless communication channel selecting unit 224 can recognize the wireless child device that has received the connection check response data before generation of the user data by referring to the used child device storage unit 221, and as a result, the wireless communication channel selecting unit 224 can recognize the wireless communication channel 30 through which the connection check response data have been received.

Each time user data is generated by the data generating unit 21, the wireless communication channel selecting unit 224 acquires the newly generated user data from the data generating unit 21.

In addition, when the wireless communication channel selecting unit 224 determines to transmit the user data through all of the first wireless communication channel 30-1, the second wireless communication channel 30-2, and the third wireless communication channel 30-3 in step S1002, the wireless communication channel selecting unit 224 outputs the user data to the data duplicating unit 225. The data duplicating unit 225 duplicates the user data, and the sequence number allocating unit 222 allocates the same sequence number to the three user data. The data duplicating unit 225 then outputs the three user data to the wireless child device (1) 23-1, the wireless child device (2) 23-2, and the wireless child device (3) 23-3. The wireless child device (1) 23-1 transmits the user data to the wireless parent station apparatus 10 through the first wireless communication channel 30-1, the wireless child device (2) 23-2 transmits the user data to the wireless parent station apparatus 10 through the second wireless communication channel 30-2, and the wireless child device (3) 23-3 transmits the user data to the wireless parent station apparatus 10 through the third wireless communication channel 30-3.

In the wireless parent station apparatus 10, when user data with the same sequence number are received through the first wireless communication channel 30-1, the second wireless communication channel 30-2, and the third wireless communication channel 30-3, the redundant data discarding unit 123 discards the two latterly received user data.

In contrast, when the wireless communication channel selecting unit 224 has selected any one wireless communication channel 30 of the first wireless communication channel 30-1, the second wireless communication channel 30-2, and the third wireless communication channel 30-3 in step S1004 or S1005, the wireless communication channel selecting unit 224 outputs the user data to which a sequence number is allocated by the sequence number allocating unit 222 to the relevant wireless child device.

As described above, even when three or more wireless communication channels are set, consumption of communication bands by redundant user data can be reduced without lowering the data arrival rate.

***Description of Hardware Configuration***

Finally, supplementary explanation of a hardware configuration of the wireless child station apparatus 20 will be provided.

In FIG. 3, at least the memory 2202 also stores an operating system (OS).

In addition, at least part of the OS is executed by the CPU 2201. The CPU 2201 executes the programs for implementing the functions of the sequence number allocating unit 222, the analyzing unit 223, the wireless communication channel selecting unit 224, and the data duplicating unit 225 while executing at least part of the OS.

A processor 901 executes the OS, so that task management, memory management, file management, communication control, and the like are performed.

Furthermore, programs to implement the functions of the sequence number allocating unit 222, the analyzing unit 223, the wireless communication channel selecting unit 224, and the data duplicating unit 225 may be stored in a portable storage medium such as a magnetic disk, a flexible disk, an optical disk, a compact disk, a Blu-ray (registered trademark) disk, or a DVD.

Furthermore, a wireless child station apparatus 20 may be implemented by an electronic circuit such as a logic integrated circuit (IC), a gate array (GA), an application specific integrated circuits (ASIC), or a field-programmable gate array (FPGA).

Note that a processor and an electronic circuit may be collectively referred to as processing circuitry.

Embodiments of the present invention have been described above; the two embodiments may be combined.

Alternatively, one of the two embodiments may be partially carried out.

Alternatively, the two embodiments may be partially combined.

Note that the present invention is not limited to the embodiments, but various modifications may be made thereto where necessary.

### REFERENCE SIGNS LIST

10: wireless parent station apparatus, 11: data generating unit, 12: wireless parent device control unit, 13-1: wireless parent device (1), 13-2: wireless parent device (2), 13-3: wireless parent device (3), 121: wireless communication channel selecting unit, 122: data duplicating unit, 123: redundant data discarding unit, 20: wireless child station apparatus, 20-1: wireless child station apparatus (1), 20-2: wireless child station apparatus (2), 20-n: wireless child station apparatus (n), 21: data generating unit, 22: wireless child device control unit, 23-1: wireless child device (1), 23-2: wireless child device (2), 23-3: wireless child device (3), 221: used child device storage unit, 222: sequence number allocating unit, 223: analyzing unit, 224: wireless communication channel selecting unit, 225: data duplicating unit, 30: wireless communication channel, 30-1: first wireless communication channel, 30-2: second wireless communication channel, 30-3: third wireless communication channel, 1101: CPU, 1102: memory, 1103: communication interface, 1201: CPU, 1202: memory, 1203: communication interface, 1204: communication interface, 1205: communication interface, 1311: CPU, 1312: memory, 1313: communication interface, 1314: wireless transmitting/receiving unit, 1315: antenna, 1321: CPU, 1322: memory, 1323: communication interface, 1324: wireless transmitting/receiving unit, 1325: antenna, 2101: CPU, 2102: memory, 2103: communication interface, 2201: CPU, 2202: memory, 2203: communication interface, 2204: communication interface, 2205: communication interface, 2311: CPU, 2312: memory, 2313: communication interface, 2314: wireless transmitting/receiving unit, 2315: antenna, 2321: CPU, 2322: memory, 2323: communication interface, 2324: wireless transmitting/receiving unit, 2325: antenna.

1.-11. (canceled)

12. A wireless communication apparatus for which a plurality of wireless communication channels are set between the wireless communication apparatus and a communication destination apparatus, the wireless communication apparatus comprising:
processing circuitry to:
receive connection check response data being a response from the communication destination apparatus in response to connection check request data transmitted to the communication destination apparatus through any of the wireless communication channels, through the wireless communication channel through which the connection check request data have been transmitted;
calculate a reception ratio of the connection check response data to the connection check request data of each of the wireless communication channels, as analysis of a condition of reception of the connection check response data;
select a wireless communication channel through which the connection check request data is to be transmitted, alternately from among the wireless communication channels, when the reception ratios of the wireless communication channels are not smaller than a threshold and the reception ratios of the wireless communication channels are of same level; and
transmit the connection check request data to the communication destination apparatus through the wireless communication channel selected.

13. The wireless communication apparatus according to claim 12, wherein
the processing circuitry selects the wireless communication channels when the reception ratios of the wireless communication channels are smaller than the threshold.

14. The wireless communication apparatus according to claim 12, wherein when transmission of user data to the communication destination apparatus is requested, the processing circuitry selects a wireless communication channel through which the user data is to be transmitted, on the basis of a result of analysis, and
the processing circuitry transmits the user data to the communication destination apparatus through the wireless communication channel selected.

15. The wireless communication apparatus according to claim 14, wherein
when a reception ratio of any of the wireless communication channels is not smaller than the threshold, the processing circuitry determines whether or not connection check response data is received after transmission of the user data is requested, and selects a wireless communication channel through which the user data is to be transmitted, on the basis of a result of determination.

16. The wireless communication apparatus according to claim 15, wherein
when connection check response data is received after transmission of the user data is requested, the processing circuitry selects a wireless communication channel through which the connection check response data is received.

17. The wireless communication apparatus according to claim 15, wherein
when no connection check response data is received after transmission of the user data is requested, the processing circuitry selects a wireless communication channel through which connection check response data is last received before transmission of the user data is requested.

18. A wireless communication method performed by a wireless communication apparatus for which a plurality of wireless communication channels are set between the wireless communication apparatus and a communication destination apparatus, the wireless communication method comprising:
receiving connection check response data being a response from the communication destination apparatus in response to connection check request data transmitted to the communication destination apparatus through any of the wireless communication channels, through the wireless communication channel through which the connection check request data have been transmitted;
calculating a reception ratio of the connection check response data to the connection check request data of each of the wireless communication channels, as analysis of a condition of reception of the connection check response data;
selecting a wireless communication channel through which the connection check request data is to be transmitted, alternately from among the wireless communication channels, when the reception ratios of the wireless communication channels are not smaller than a threshold and the reception ratios of the wireless communication channels are of same level; and
transmitting the connection check request data to the communication destination apparatus through the selected wireless communication channel.

19. A non-transitory computer readable medium storing a wireless communication program causing a wireless communication apparatus, for which a plurality of wireless communication channels are set between the wireless communication apparatus and a communication destination apparatus, to execute:
a reception process of receiving connection check response data being a response from the communication destination apparatus in response to connection check request data transmitted to the communication destination apparatus through any of the wireless communication channels, through the wireless communication channel through which the connection check request data have been transmitted;
an analysis process of calculating a reception ratio of the connection check response data to the connection check request data of each of the wireless communication channels, as analysis of a condition of reception of the connection check response data;
a wireless communication channel selection process of selecting a wireless communication channel through which the connection check request data is to be transmitted, alternately from among the wireless communication channels, when the reception ratios of the wireless communication channels are not smaller than a threshold and the reception ratios of the wireless communication channels are of same level; and
a transmission process of transmitting the connection check request data to the communication destination apparatus through the wireless communication channel selected in the wireless communication channel selection process.
